(19) United States
(12) Patent Application Publication
(10) Pub. No.: US 2012/0041794 A1
(43) Pub. Date: Feb. 16, 2012

(54) METHOD AND SYSTEM TO VALIDATE COMPONENT-BASED IMPLEMENTATIONS OF BUSINESS PROCESSES

(75) Inventors: Jens Lemcke, Karlsruhe (DE); Andreas Friesen, Steinfeld (DE); Tirdad Rahmani, Karlsruhe (DE)

(73) Assignee: SAP AG, Walldorf (DE)

(21) Appl. No.: 12/854,026

(22) Filed: Aug. 10, 2010

(51) Int. Cl. G06Q 10/00

(52) U.S. Cl. 705/7.11

(57) ABSTRACT

A computer-implemented method and system to validate component-based implementation of business processes are provided. The method comprises accessing an abstract business process and a specific business process. The specific business process includes sub-steps that refine a step in the abstract business process. A refinement between the abstract business process and the specific business process is validated using a first Petri Net. Component models are accesses, where the respective component models describe an operation performed by a component corresponding to the component model. A grounding between the sub-steps and the component models is validated using a second Petri Net.

### FIELD OF THE INVENTION

This disclosure relates generally to the field of business process management and particularly to validation of a component-based implementation of business processes.

### BACKGROUND

Business process models play an important role in facilitating the understanding of how companies operate and in providing a blueprint for software systems supporting these processes. The automation of a business process, during which documents, information, or tasks are passed from one participant to another for action according to a set of procedural rules, may be termed a workflow. A workflow may be expressed by a workflow model (also referred to as a process model). Workflow models may be generated using a graphical process modeling language. Typically, graphical process modeling languages allow for expressing control-flows, or ordering dependencies among tasks, in a process. Executing a process based on a workflow model and specific input data may be referred to as executing an instance of a workflow. When an instance of a workflow has completed executing or is cancelled, another instance of the workflow may be started, e.g., with new input data.

In large organizations, many tasks, such as those related to expenses, need to be approved before they are performed. For instance, a purchase order may need to be approved by several roles, depending on the value and the type of the items listed in the purchase order, and on the ordering agent's position in the organization's hierarchy. A purchase approval process may be expressed by a workflow model (e.g., titled a purchase workflow model). A computerized purchase approval process based on the purchase workflow model may be termed a purchase approval workflow. Each time a new purchase order needs to be processed, a new instance of the purchase approval workflow may be started.

To generate a workflow from a business process model, a set of generic components from different vendors is customized and integrated to implement the specific business process of an organization. More specifically, enterprise application integration (EAI) activity consists of data integration, data flow integration and control flow integration. In control flow integration, it is important that the business process model and the process and component behavior is kept consistent.

Some of the research for control flow integration proposes a method to generate an integration that is either fully automatic with a certain degree of confidence, or semiautomatic from a formal specification. Both approaches have their downsides. In the fully automated case, the generated integration comes with a degree of confidence which is always below certainty. Therefore, no matter how good the machine's guess was, the integration has to be entirely checked by the consultant. The semi-automatic case can be seen as an intention-based approach. The consultant expresses their intention of the integration, for example in the form of policies, and the system generates an according integration. However, expressing one's intention can be assumed to be as hard as creating the integration directly: policies could conflict with each other, miss desired cases, or cover unwanted cases. The result is a natural human dislike towards automatic wizards operating on behalf of the consultant because, in the end, it is the consultant's personal responsibility that components are integrated correctly and do not cause costly business disruptions at run time.

### BRIEF DESCRIPTION OF DRAWINGS

Embodiments are illustrated by way of example and not limitation in the figures of the accompanying drawings, in which like references indicate similar elements and in which:

FIG. 1 is a diagrammatic representation of a business process grounded to corresponding components to perform the business process, in accordance with an example embodiment.

FIG. 2 is a diagrammatic representation of a refinement of a specific business process, in accordance with an example embodiment.

FIG. 3 is a block diagram showing an example validation engine, in accordance with an example embodiment.

FIG. 4 is a diagrammatic representation of transformations of vertices in a process model written using business process modeling notation (BPMN) into Petri Net structures, in accordance with an example embodiment.

FIG. 5 is a flowchart illustrating a method for validating grounding of a business process using a Petri Net, in accordance with an example embodiment.

FIG. 6 is a diagrammatic representation of a process model and a process net generated based on the process model for validating grounding of the process model, in accordance with an example embodiment.

FIG. 7 is a diagrammatic representation of a grounding net, in accordance with an example embodiment.

FIG. 8 is a flowchart illustrating a method for validating refinement of a business process using a Petri Net, in accordance with an example embodiment.

FIG. 9 is a diagrammatic representation of a process model and a process net generated based on the process model for validating refinement of the process model, in accordance with an example embodiment.

FIG. 10 is a first diagrammatic representation of a refinement net, in accordance with an example embodiment.

FIG. 11 is a second diagrammatic representation of a refinement net, in accordance with an example embodiment.

FIG. 12 is a diagrammatic representation of a machine in the example form of a computer system within which a set of instructions, for causing the machine to perform any one or more of the methodologies discussed herein, may be executed.

### DETAILED DESCRIPTION

A computer-implemented validation system for component-based implementation of business process, in one example embodiment, provides a way to link business processes to information technology (IT) components and to validate those linkages using Petri Nets. Due to the downsides of automated approaches, a fully manual approach is provided that lets the consultant model the integration, but provides a verification that shows mismatches between the business process activities grounded to the components' operations, referred to herein as “grounding validation.”

In addition, the consultant's transformation of a business process intention into an integration of the business process into an IT system is supported by a means of verifying correctness of process model refinement, referred to herein as “refinement validation.” For example, a process model refinement may be a sketch of the process to be integrated can be modeled as an abstract process model A. A more specific process B can be modeled together with a relation stating for each substep b of B which step a of A it refines. The refinement relation can be seen as covering the purpose of each step b, namely, implementing parts of the corresponding abstract step a. Likewise, the refinement relation describes the business semantics of each step a, namely, as consisting of all corresponding substeps b. As such, refinement validation checks whether B preserves the control flow of A.

For both grounding validation and refinement validation, a problem reduction to Petri Net verification is performed. One objective is to support the implementation of business processes described by business process models. As used herein, a process model (that may represent a business process is a non-simple directed graph P= [symbol] E, V [symbol] without multiple edges between two vertices. In the embodiments described herein the Business Process Modeling Notation (BPMN) is used as a graphical representation. As used herein, vertices (V) fall into events, activities, and gateways (Σ,A,G⊂V). An event is either a start or an end event (Σ^{S}, Σ^{E}⊂Σ, E^{S}∩Σ^{E}=Ø). A gateway is either exclusive or parallel (G^{E}, G^{P}⊂G, G^{E}∩G^{P}=Ø). The edge set (E) is a binary relation on vertices V. The predecessor and the successor functions of each v₁εV are defined as follows: pre(v₁):={v₂εV|(v₂, v₁)εE}, suc(v₁):={v₃εV|(v₁, v₃)ε}. The start (end) event σ^{S}εΣ^{S} (σ^{E}εΣ^{E}) has no predecessors (successors): |pre(σ^{S})|=|suc(σ^{E})|=0.

Special software engineering phases for developing a component-based implementation of a business process are available. The development process allows implementing a business process by utilizing and extending existing enterprise services from the component vendor. Generally, the phases of the development process are: identifying business requirements, service modeling, service definition, service implementation, discovery & description, and service consumption. Business requirements are collected and matched against existing service offers. For missing functionality, new services may be modeled, defined, implemented, and described as part of new components in the respective phases. The actual implementation of the business process is done in the service consumption phase when a process is performed by the users of the system.

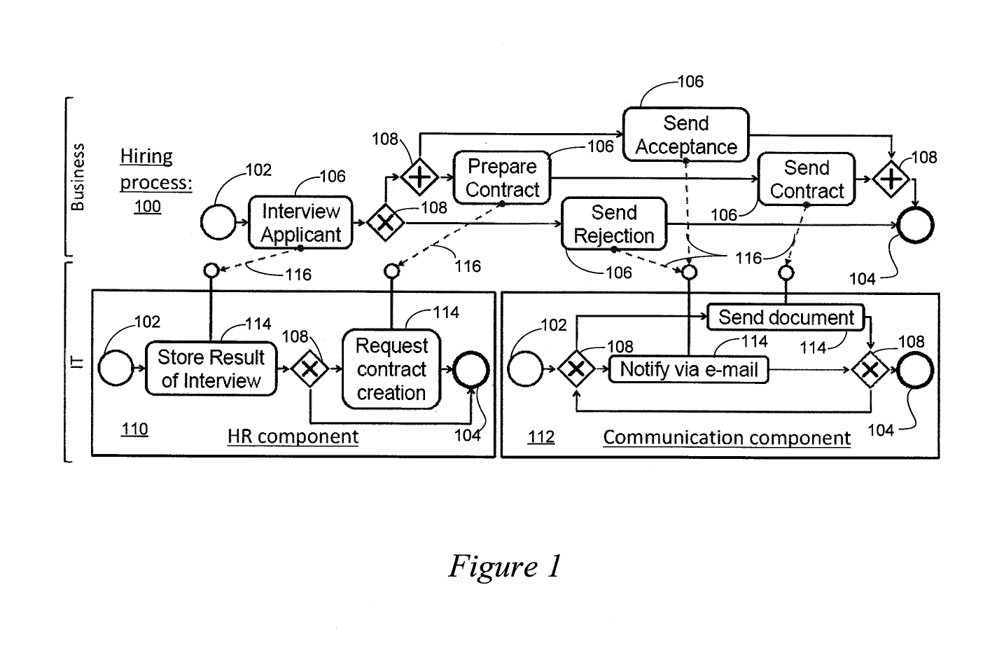

In the service consumption phase, the developer creates a business process model and links, or “grounds,” each process step to an operation of a service of one of the existing or custom-developed components, as shown in FIG. 1. Grounding is a function that links activities to operations. An exemplary grounding (grounding 116) shown in FIG. 1 (and discussed below) is grnd(Prepare Contract)=Request Contract Creation (depicted by dotted line). The grounded business process can be deployed to a runtime environment and executed in daily business. Therefore, a grounded process may be an integration of the involved components.

In order to provide integrations, component descriptions include a technical contract description of the behavior of the services provided by the components. In contrast to process models that describe the active performance of activities that consume time, a component model defines passive constraints on technical, atomic operations. Different types of components can be distinguished. Some components described by the component models may document business processes, for example, to create and to maintain orders or invoices. Others can provide a user interface that presents and requests information to and from humans. For simplicity, the syntax and graphical notation described above are used for process and component models except that, for components, “operation” is used instead of “activity.”

FIG. 1 is a diagrammatic representation of a business process grounded to corresponding components to perform the business process, in accordance with an example embodiment. A business process and IT components used to perform the business process are shown. The business process, hiring process 100, begins with start event 102 and ends with end event 104. The hiring process 100 includes activities 106 such as “Interview Applicant,” “Send Acceptance,” “Prepare Contract,” “Send Contract,” and “Send Rejection.” The activities 106 are linked via gateways 108 to implement the hiring process 100.

The IT components shown in FIG. 1 include a Human Resources (HR) component 110 and a communication component 112. Like the Hiring process 100, each component includes a start event 102, an end event 104, and one or more gateways 108. Further, each component (e.g., HR component 110 and communication component 112) is to perform one or more operations 114. FIG. 1 further depicts groundings 116 between the activities 106 in the hiring process 100 and the operations 114 performed by the components. As depicted, each operation 114 may correspond to one or more activities in the hiring process 100.

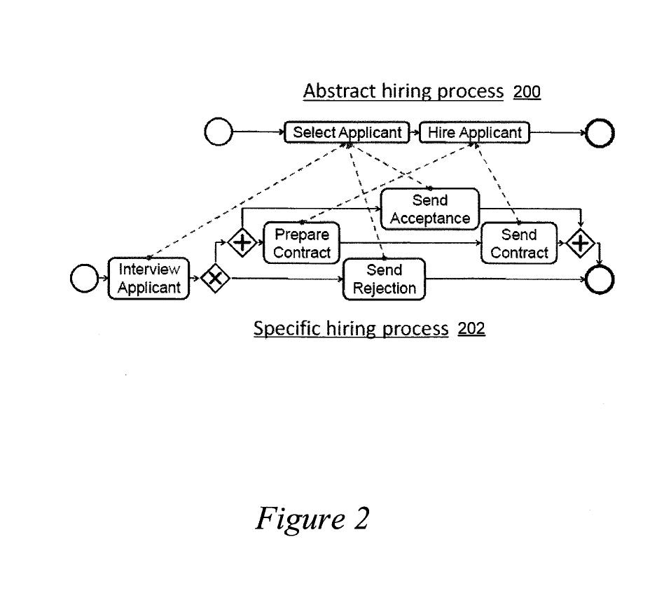

As illustrated by FIG. 2, a complex business process may not be created in one step and its development may involve multiple roles (e.g., people) in the service consumption phase. Typical roles are business expert, business analyst, and process architect who create process models at different abstraction levels by refinement as shown in FIG. 2. The sub-steps of service consumption performed by the different roles are subject to the specific ordering that the overall software development process implies. Refinement is a function that declares which activity of a more specific process originates from which activity of a more abstract process. The more specific process may map to a single, more abstract step. The more abstract step may map to more than one more specific process.

An exemplary incorrect refinement in the following figure is provided in FIG. 2 as orig(Prepare Contract)=Hire Applicant. More specifically, FIG. 2 shows a higher level abstract hiring process 200 comprising activities “select applicant” and “hire applicant” in series. The specific hiring process 202 includes the sub-steps shown FIG. 1. The sub-steps, however, are connected in a way that causes the “hire applicant” step to be performed before the “select applicant” step is completed. As shown, the sub-step “prepare contract” that corresponds to the step “hire applicant” may be performed before the sub-step “send acceptance” (corresponding to the step “select applicant”) is performed.

The challenge of large business process engineering projects is that a multitude of process models are created whose consistency needs to be ensured. A refinement mistake that occurs in an early development phase may have very costly implications if the development process proceeded before the error was detected—all affected models and implementations may have to be adapted. In the worst case, the implemented business process does not observe the requirements posed by the abstract process.

Consistency does not only have to be ensured during the initial creation of process models, but also when change occurs. Especially the re-iteration of the engineering process back to recently created abstraction layers is typical for agile software engineering processes and leads to change on some higher abstraction layer. Now, it has to be identified which of the already existing models are affected by the inconsistency and whether their subsequent correction was successful. These tedious and error-prone checking tasks can be automated by the validations described herein.

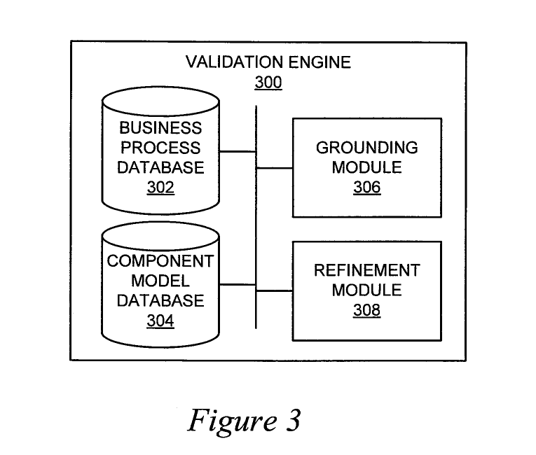

FIG. 3 is a block diagram showing an example validation engine 300, in accordance with an example embodiment. The validation engine 300 may be implemented using one or more processors or computers systems. The validation engine 300 is configured to validate grounding and refinement of business processes.

The validation engine 300 accesses, and may include, a business process database 302. The business process database 302 stores business process models, where each respective business process model may be associated with one or more levels of abstraction (e.g., abstract hiring process 200 and specific hiring process 202). The business process models may be stored in the BPMN format used in the described embodiments or in another business process modelling format.

The validation engine 300 additionally accesses, and may include, a component model database 304. The component model database 304 stores a plurality of component models (e.g., HR component 110 and communication component 112) that each, in turn, describes one or more predetermined operations.

The grounding module 306 performs validating operations based on grounding between business process models and the component models as described herein by generating one or more Petri Nets. Similarly, the refinement module 308 performs validating operations based on refinements between abstract business process models and specific business process models as described herein by generating one or more Petri Nets.

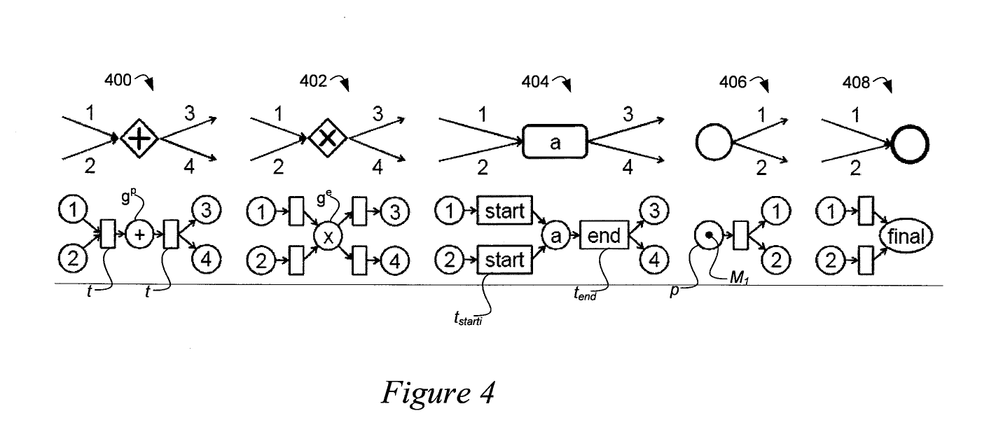

A transformation of process models to Petri Nets which may be used in the description of the embodiments is provided in FIGS. 4-11. A Petri Net is a triple (P,T,F), where P is a finite set of places, T is a finite set of transitions, where P∩T=Ø and F⊂(P×T)∪(T×P) is a set of arcs referred to as a “flow relation.” Graphically, a place is denoted by an ellipse and a transition by a rectangle as in the FIG. 4. The set of input and output places of a transition t is defined as in(t)={pεP|(p,t)εF} and out(t)={pεP|(t,p)εF}. Similarly, the input and output transitions of a place p can be defined as in(p)={tεT|(p,t)εF} and out(p)={tεT|(t,p)εF}. A place or transition targetεP∪T is reachable from another place or transition sourceεP∩∪T if there is a directed path from source to target in the transitive closure of F. The state, or marking, of a Petri Nets is an assignment of tokens to places: MεP→N. Graphically, a token is represented as a black dot inside a place.

Petri Net executions are mathematically defined based on the firing of transitions; a transition can only fire if it is enabled. A transition is only enabled if all input places contain at least one token. When a transition fires, one token is consumed from each input place and one token is produced in each output place. An execution e of a Petri Net is a sequence of markings: e=(M₁, M₂, . . . , Mₙ), where M₁ is the initial marking and Mᵢ₊₁ is the marking resulting from firing one transition in Mᵢ for all 1≦i≦n. A Petri Net has a deadlock if there is at least one marking Mᵢ in any execution in which no transition is enabled.

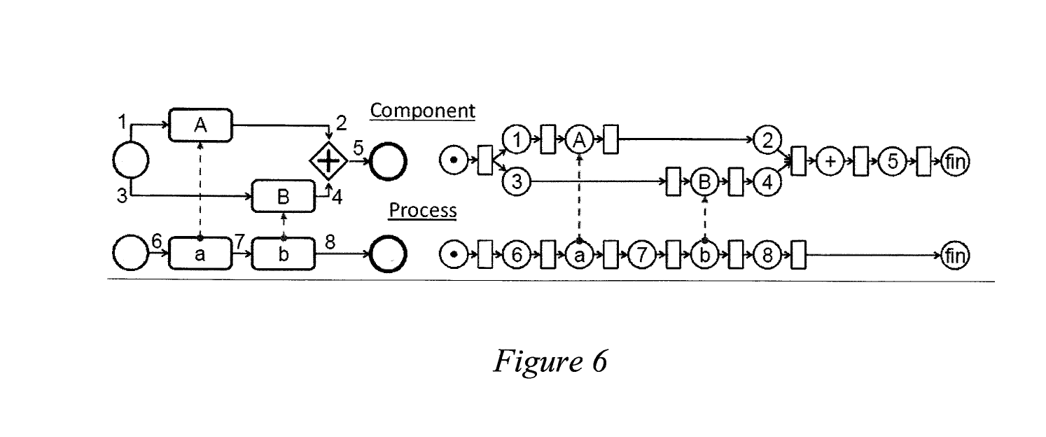

Due to the mathematical definition of Petri Net execution, mapping a process model on a Petri Net gives execution semantics to the process model. The formal transformation described here corresponds to the only verbally described token flow semantics of BPMN. The specific Petri Net created for a process model is referred to as “a process net.” The transformation of the individual elements is displayed in FIG. 4. An example of the transformation of a whole BPMN diagram to a Petri Net is shown in FIG. 6.

In BPMN's token flow semantics, tokens are held by edges. Therefore, a new place pεP is created in the process net for each edge eεE in the process model and store the correspondence in the relation E2P⊂E×P.

FIG. 4 is a diagrammatic representation of transformations of vertices in a process model written using business process modelling notation (BPMN) into Petri Net structures, in accordance with an example embodiment. Activities and gateways consume and produce tokens in BPMN's token flow semantics. As displayed in FIG. 4, each kind of process model vertices are transformed differently to Petri Net structures due to their different behavior.

As shown in conversion 400, a parallel gateway g^{p} is used to synchronize and fork concurrent strands. Therefore, a new transition t is created for g^{p} 400 and connected to the places corresponding to g^{p}'s incoming and outgoing edges. A new arc (pᵢₙ, t)εF is created in the process net for each incoming edge eᵢₙε{(vᵢₙ, g^{p})εE} of the parallel gateway, where (eᵢₙ,pᵢₙ)εE2P. A new arc (t,pₒᵤₜ)εF is created for each leaving edge eₒᵤₜε{(g^{p}, vₒᵤₜ)εE}, where (eₒᵤₜ, pₒᵤₜ)εE2P.

As shown in conversion 402, an exclusive gateway g^{e} can split and merge alternative strands. Therefore, a new interim place is created for g^{e} which gets connected to a new transition per incoming and outgoing edge.

As shown in conversion 404, an activity a acts like an exclusive gateway for the incoming edges and like a parallel gateway for the leaving edges. Therefore, a new interim place—the activity place—is created for which a new input transition tₛₜₐᵣₜ is created per incoming edge, and one output transition t_{end} connecting all places corresponding to the leaving edges at once. It is to be noted that this transformation naturally separates the starting of an activity represented by the transitions tₛₜₐᵣₜ, called start transitions, and the ending of an activity represented by t_{end}, called end transition.

As shown in conversion 406, every start event σ^{S} is a concurrent starting point of the process and contains a token in BPMN's token flow semantics. Therefore, for the start event a new place p—the starting place—is created that contains a token in the initial marking M₁. A start event has no incoming edges and acts like a parallel gateway for the leaving edges. Therefore, a new transition is created and connected top as well as to all places corresponding to the leaving edges. The initial marking is the marking where one token is in every starting place and there are no other tokens in the net.

As shown in conversion 408, every end event σ^{S} consumes incoming tokens like an exclusive gateway. To ease the process net, a single place is created for all end events—the final place. The final place is connected to a new transition per incoming edge of each end event. A final marking is a marking where tokens are only in the final place.

The process models to be checked for refinement and grounding are assumed to be sound before entering the respective validations. As the process models are graph-based, the soundness criterion for processes is based on properties of the graph structure of a process net as described below.

First, a process model is only sound if the corresponding process net has no livelocks and never stalls. A process net stalls, if it has a deadlock in a non-final marking. A process net has a livelock if there is at least one execution that can never reach a final marking.

If desired, plausibility checks can be performed before or after the refinement and grounding checks, except the named no-livelock and no-stalling requirements, which may be ensured before grounding and refinement checks. One possibility for ensuring these properties includes model-checking the corresponding Petri Net.

The grounding module 306 validates a generated grounding. In some embodiments, the requirements for correct grounding include that: first, a process is completely grounded if and only if every of its activities is grounded on some operation. The operations a process grounds on may stem from different components as shown in FIG. 1.

The definition of correct grounding used in some embodiments is based on a maximal execution set semantics where the semantics of a process p is understood as its, possibly infinite, execution set P. Then, two subsumption semantics—maximal execution set semantics and minimal execution set semantics—are described based on relations of the execution sets.

Based on the semantics of process models given through the mapping on Petri nets, execution sets of processes are defined. An execution is a proper, finite sequence of activities aᵢεA, denoted by [a₁,a₂, . . . , aₙ]. A proper sequence is obtained by executing the corresponding process net until a deadlock occurs. Whenever a start transition of an activity a is fired in the process net, a is appended to the sequence. The result is a proper sequence of activities—an execution. It is to be noted that each execution is finite. However, there may be an infinite number of executions for a process model. The execution set of a process model is the (possibly infinite) set of all proper sequences of the process model.

First, a process p₁ subsumes another process p₂ under the maximal (minimal) execution set semantics if P₂⊂P₁(P₁⊂P₂). The grounding validation is based on the maximal execution set semantics because, informally, a subsumed process can neglect alternatives in executions, but has to follow the general behavior of the superior process. Correspondence between process and component must be established before their execution sets can be compared; each execution of the process must be projected to only those activities that are grounded to the component. Additionally, each activity must be substituted by the operation it grounds to. The resulting execution set is called projected and substituted execution set.

Second, a process correctly grounds to a component if and only if the component's execution set subsumes the projected and substituted execution set of the process. It is noted that the subsumption of possibly infinite execution sets cannot be computed directly. Therefore, the problem is reduced to the analysis of Petri Net executions. The idea behind grounding validation with Petri Nets is combining a component model, a process model, and the grounding relation to a new Petri Net such that the following properties are observed. In one example embodiment, the properties are designed to reflect the passive (active) nature of component (process) models, as listed below.
(1) Every step performed by the component (process) model must correspond to BPMN's token flow semantics.
(2) A step in the process model performing an activity a must result in a step in the component model that performs the operation o if a grounds on o.
(3) A step of the process model must result in some checkable error if the process model is not subsumed by the component model under maximal execution set semantics.
(4) The component model must never perform a step on its own.
(5) The process model must be able to perform all allowed executions.
   Reducing the grounding validation to the analysis of Petri Nets can be understood as exploring the correspondence of the execution sets step for step. Subsumption is achieved as the component model has to “follow” the process model.

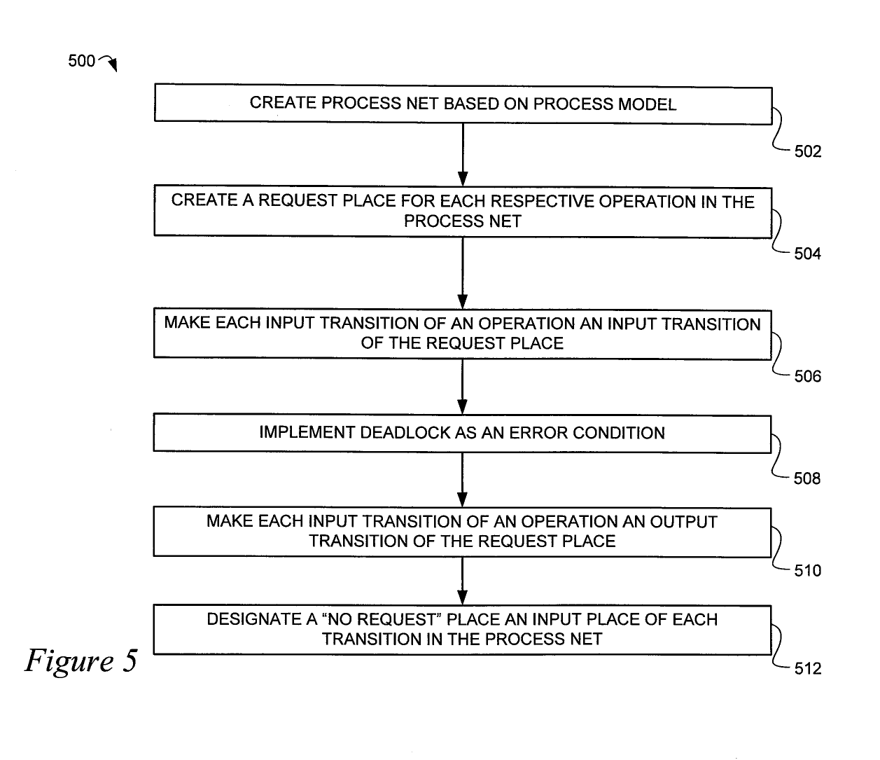

FIG. 5 is a flowchart illustrating a method for validating grounding of a business process to one or more components using a Petri Net, in accordance with an example embodiment. To validate the grounding, the grounding module 306 may perform a grounding validation process 500. More specifically, the grounding is checked for a pairing of one process model and one component model. However, the following procedure can be modified to validate one process and all components it grounds on simultaneously.

In a step 502, a process net (e.g., a Petri Net corresponding to the process) is created from the process model as described above. For the component model, the same transformation into a Petri Net, yielding a component net, is performed. An activity place is called operation place in a component net. Both transformations are illustrated in FIG. 6. FIG. 6 is a diagrammatic representation of a process model and a process net generated based on the process model for validating grounding of the process model, in accordance with an example embodiment. In FIG. 6, it is also illustrated by dashed arrows below that grounded places in the process net are similar to grounded activities.

For the remainder of the transformation, end events are treated like activities due to their similar execution semantics. The process' final place p_{final process} is connected to the component's final place p_{final component} in the grounding function: grnd(p_{final process})=p_{final component}.

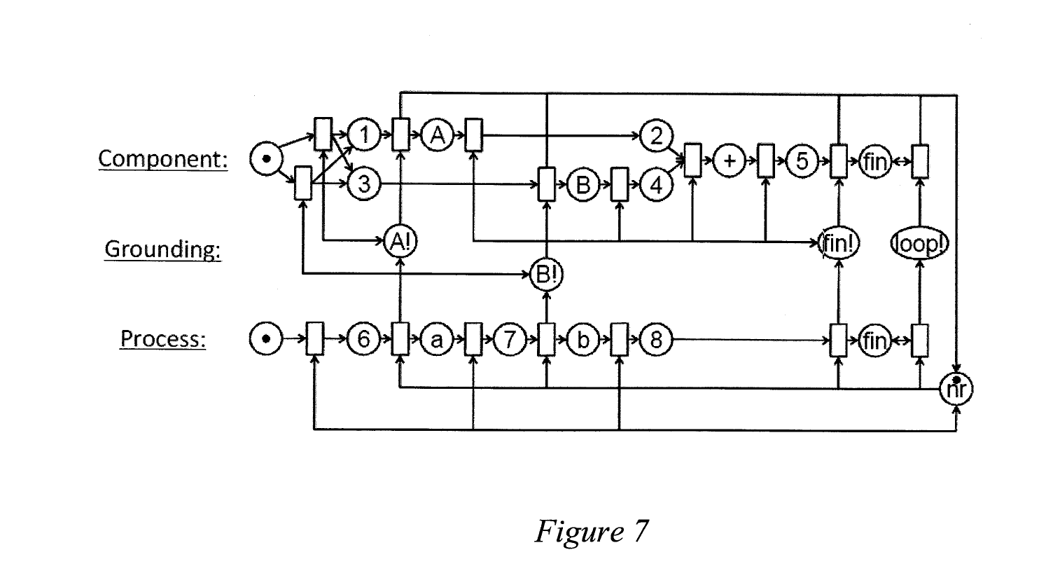

The five requirements for designing properties discussed above are implemented by merging both the component and the process net to a grounding net. In the grounding net, the executions of the process and the component net are strictly separated. That means that either the component or the process model may perform a step at a time, but not both of them. The executions are synchronized by a notion of request. To illustrate the construction procedure, the complete grounding net for FIG. 6 is shown in FIG. 7. FIG. 7 is a diagrammatic representation of the grounding net, in accordance with an example embodiment.

Returning to FIG. 5, in a step 504, starting a grounded activity a in the process 500 is understood as a request to start the respective operation o in the component. As such, a request place o! is created per operation o.

In a step 506, in this embodiment, the request place o! should contain a token if and only if o that was requested by a. Therefore, every input transition of a is made an input transition of o!. Furthermore, o should only be executed if it was requested. Therefore, o! is made an input place of every input transition of o. As an example, the new request place B! becomes output (input) place of b's (B's) start transition in FIG. 7.

In a step 508, deadlock as an error condition required in step 506 is used for the grounding validation. Deadlock detection is a standard task performed on Petri Nets. Deadlock detection returns a positive answer if at least one deadlock can be found in the net. Otherwise, the answer is negative. This decision implies that neither the component nor the process net must contain any deadlocks when they are sound. However, a sound process or component net may deadlock in a final marking. Therefore, a new transition t—the final loop transition—is added to each final place p and connected by the two opposite arcs (p,t) and (t,p), graphically denoted by one arc with two heads. Now, neither the process nor the component model can cause a deadlock if it is sound (as assumed). To implement the request notion also for the process'(component's) loop transition t_{loop process} (t_{loop component}), a loop request place loop! is created and made an output (input) transition of t_{loop process} (t_{loop component}).

In a step 510, according to step 508, the component should never perform a step on its own. For the input transitions of operations, this is ensured by connecting them from the request places. For every remaining transition t of the component net, each t is substituted by a new transition tₒ for each operation place o that is (syntactically) reachable from t and connected as both an input and an output transition of the corresponding request place o!.

In a step 512, once an operation is requested, only the component should be able to perform a requested operation. Therefore, a no-request place nr is created that should contain a token if and only if no request place contains a token. The no-request place nr is made an input place of all transitions in the process net. This still allows for arbitrary steps of the process as required in step 510. Specific transitions that are not connected to request places additionally become input transition to nr as the no-request place should contain a token if no request place contains a token. In order to ensure that the process may perform a step as long as nothing was yet requested in the beginning of an execution, the no-request place initially contains a token. Furthermore, the process should also be able to perform a step after a requested operation was started—in other words: the request was completed. Therefore, every input transition of any operation place in the component net becomes an input transition to nr.

As there may only be a token in one of the request places or in the no-request place, the process cannot proceed as long as a request is in progress. The properties of an execution of the grounding net shown in FIG. 7 are listed below.
(1) If there is a token in nr, no request is in progress and only the process net may perform a step (e.g., an activity). The process net can perform arbitrary steps that are in accordance with the process model.
(2) If there is a token in any request place, a request is in progress and only the component net may perform a step. The component net can only perform steps that are in accordance with the component model. In addition, the component net can only perform a step that contributes to the current request. That is, no step can lead to a different than the requested operation place.
(3) A deadlock occurs if and only if an operation is requested, but cannot be executed.

Deadlock analysis of a Petri Net may be performed by constructing the Karp-Miller coverability tree. In alternate embodiments, other efficient optimizations may be used to perform the state space analysis. For example, the stubborn set method and the sleep set method can be performed. The root is the initial marking. A branch is a transition. A branch connects a first marking with another marking that results from firing the transition in the first marking. A marking where no transition is enabled identifies a deadlock. The path from the root is the execution that causes the deadlock. Constructing the coverability tree also deals with loops and infinitely growing numbers of tokens in addition to what was said here.

Whether or not the process correctly grounds on the component can be determined by deadlock analysis using the coverability tree of the grounding net. In addition, the cause for an incorrect grounding can be determined from the execution causing the deadlock. The last transition of the execution is the start transition of the activity that would violate the component model. Removing all but the activity (operation) start transitions from the grounding net's execution yields the execution of the process (component) involved in the violation. That information may help the software engineer to understand and correct the process.

To validate refinement between an abstract business process and a specific business process as described in connection with FIG. 2, various requirements are observed. In general, two processes may participate in refinement: the (more) abstract and the (more) specific process. The abstract process is understood as control flow requirements to be observed in the more specific process.

The semantics of the abstract process differs slightly from the semantics used to express grounding in that not all activities are atomic, but the decomposition of abstract activities is allowed in the specific process. That means that an abstract activity a may stay active while multiple specific activities are performed that refine a.

Correct refinement can be defined based on maximal execution set semantics, minimal execution set semantics, or behavioral equivalence depending on the use case. Maximal execution set semantics is desired if variants are specified in the abstract process such as credit card and cash payment. The specific process may then implement some of the variants, but it can neither introduce different flows nor executions with additional activities. Minimal execution set semantics is useful if the abstract process is to be understood as obligatory control flow requirements that must not be circumvented in the specific process. However, the specific process can be enriched by further flow through the existing activities and executions with new activities. For example, obeying the core process of an enterprise consisting of order, produce, ship, and invoice would be an obligatory requirement. Behavioral equivalence holds if and only if both minimal and maximal execution set semantics hold. All abstract and specific executions must correspond to each other. This is the default for refinement checking.

Requirements for maximal execution set semantics for atomic activities were previously defined in connection with grounding validation. For decomposition considering maximal execution set semantics, the second requirement is adapted so that (2′) one step in the specific process model must result in the corresponding step in the abstract process model if the steps are connected by the refinement relation. If the abstract process already performs the requested step, the abstract process may also stay in that step. The requirements for minimal execution set semantics can be achieved by swapping the roles of the abstract and specific processes. For decomposition considering minimal execution set semantics, the second requirement is reformulated to: (2″) one step in the abstract process model must result in the corresponding step in the specific process model if the steps are connected by the refinement relation. Every step in the abstract model can arbitrarily often request a corresponding step in the specific model. The requirements for behavioral equivalence are the union of the requirements for minimal and maximal execution set semantics.

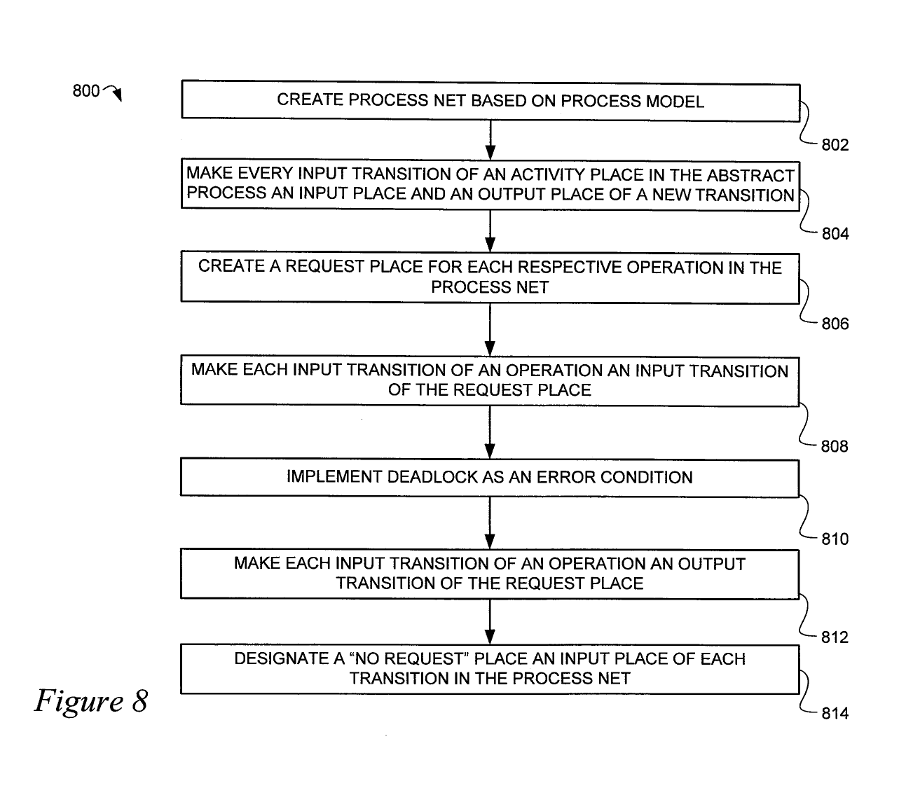

The Petri Net for validating refinement—the refinement net—is constructed along the same approach as steps 502 to 512 described above for the grounding validation method 500 of FIG. 5 with a few exceptions. FIG. 8 is a flowchart illustrating a method 800 for validating refinement of a business process using a Petri Net, in accordance with an example embodiment.

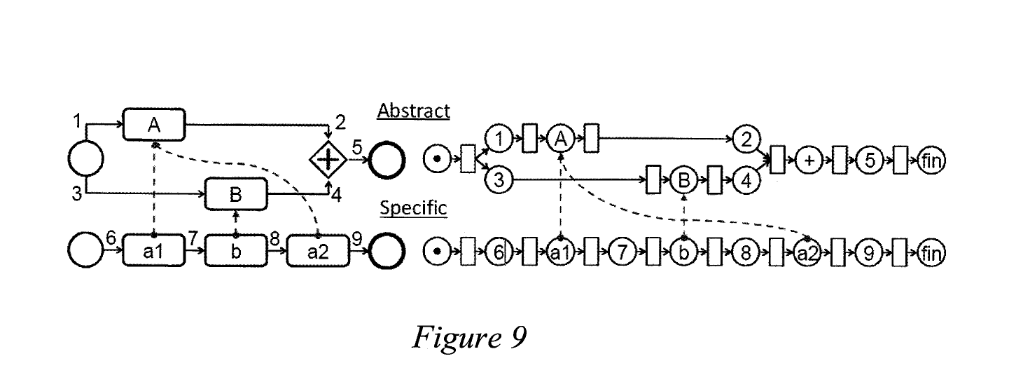

The transformation from process models to Petri Nets in a step 802 yields, in the case of refinement, an abstract and a specific process net as depicted in FIG. 9. FIG. 9 is a diagrammatic representation of a process model and a process net generated based on the process model for validating refinement of the process model, in accordance with an example embodiment.

The additional feature of refinement relative to grounding is the decomposition of activities. Therefore, between steps 802 (corresponding to step 502) and 806 (corresponding to step 504), in step 804, every input transition of an activity place a in the abstract process becomes input and output place of a new transition: the “still-in” transition of a, or: “still-in-a”.

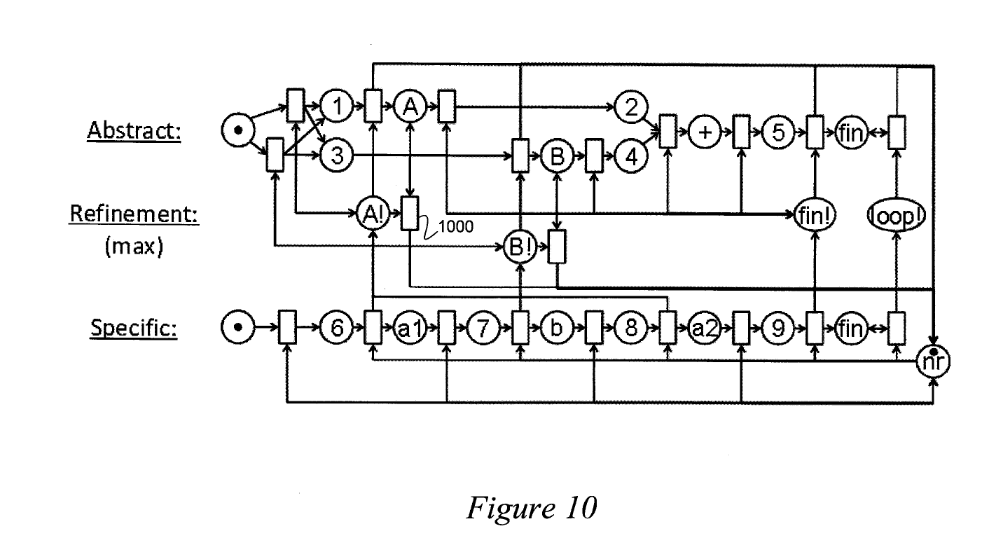

For maximal execution set semantics, the remaining steps 806 to 814 are the same as for constructing the grounding net. The “still-in” transitions allow the abstract process to keep executing an abstract activity when multiple specific occurrences in the specific process request the same abstract activity, which was required in (2′). FIG. 10 is a first diagrammatic representation of a refinement net, in accordance with an example embodiment. FIG. 10 illustrates that the start of the specific sub-activity “a2” poses a request for activity “A” (place “A!”) while “A” was already started by “a1”. Due to the new still-in-A transition 1000, the request from “a2” to perform “A” can still be granted because “A” has not been left since it was initially started by “a1”.

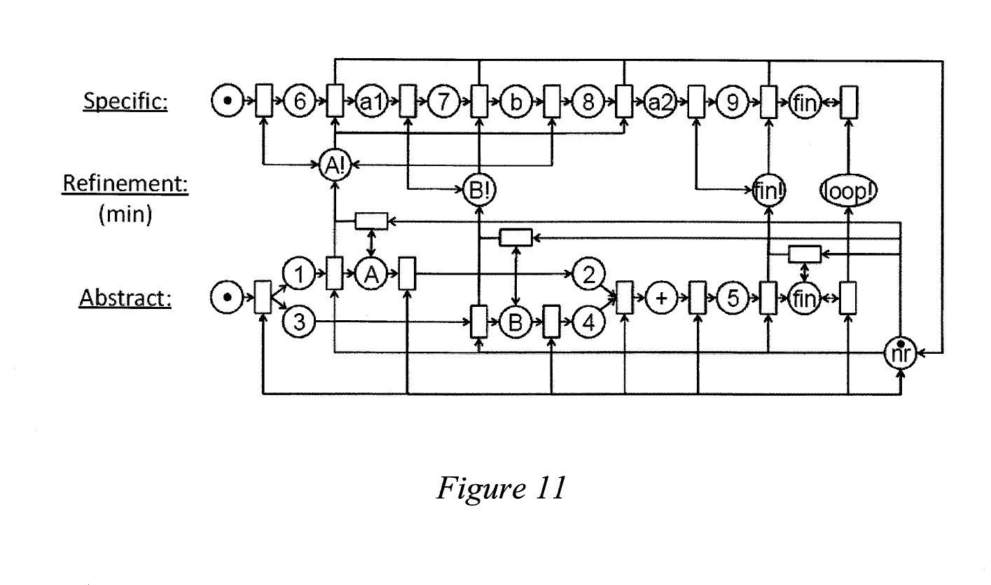

FIG. 11 is a second diagrammatic representation of a refinement net, in accordance with an example embodiment. For minimal execution set semantics, step 806 (corresponding to step 504) is the same as for constructing the grounding net. In the remaining steps 806 to 812, the abstract and the specific process are exchanged. The adapted requirement (2″) is covered as the swapping of abstract and specific process is performed after introducing the still-in transitions. FIG. 11 shows the resulting refinement net.

Each still-in transition t of activity a allows for an alternative to the original execution of the abstract process net through firing t instead of firing any original output transition of a. For checking minimal execution set semantics that means: An abstract activity has to stay active for corresponding specific activities that become active in the future. If no corresponding specific activities become active in the future, then the abstract net may proceed. It suffices for the correctness of refinement that only one alternative does not result in a deadlock and can therefore differentiate between relevant and irrelevant deadlocks.

A relevant deadlock can be determined from the Karp-Miller coverability tree as being relevant if and only if the corresponding execution only consists of deadlock-relevant markings. Deadlock-relevance of a marking M₁ depends on the deadlock-relevance of all markings that are connected from M₁ in the coverability tree grouped such that for every still-in-a transition t enabled in A, the set Mₜ contains all markings reached by firing in M₁ any original (as opposed to a still-in) transition enabled by a. M₁ is deadlock-relevant if and only if: no transitions are enabled, i.e., the marking is deadlocked, or (at least) one still-in transition t leads to a deadlock-relevant marking and Mₜ contains (at least) one deadlock-relevant marking, or the marking reached by any other transition is deadlock-relevant. Behavioral equivalence is verified by performing both the validation for minimal and for maximal execution set semantics.

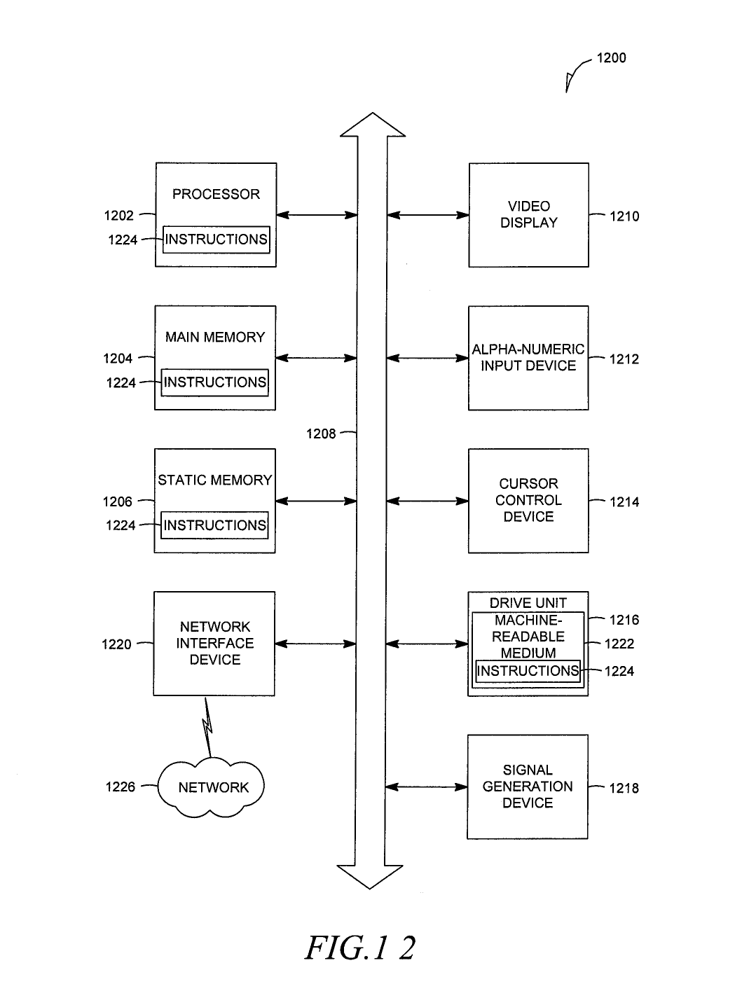

FIG. 12 is a diagrammatic representation of a machine in the example electronic form of a computer system 1200 within which a set of instructions, for causing the machine to perform any one or more of the methodologies discussed herein, may be executed.

In various embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a portable music player (e.g., a portable hard drive audio device such as an “Moving Picture Experts Group (MPEG) Layer 3” (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a user interface (UI) navigation device 1214 (e.g., a mouse), a disk drive unit 1216, a signal generation device 1218 (e.g., a speaker) and a network interface device 1220.

The disk drive unit 1216 includes a machine-readable medium 1222 on which is stored one or more sets of instructions and data structures (e.g., software 1224) embodying or utilized by any one or more of the methodologies or functions described herein. The software 1224 may also reside, completely or at least partially, within the main memory 1204 and/or within the processor 1202 during execution thereof by the computer system 1200, the main memory 1204 and the processor 1202 also constituting machine-readable media.

The software 1224 may further be transmitted or received over a network 1226 via the network interface device 1220 utilizing any one of a number of well-known transfer protocols (e.g., Hyper Text Transfer Protocol (HTTP)).

While the machine-readable medium 1222 is shown in an example embodiment to be a single medium, the term “machine-readable medium” may be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media. Such medium may also include, without limitation, hard disks, floppy disks, flash memory cards, digital video disks, random access memory (RAMs), read only memory (ROMs), and the like. The term “machine-readable storage medium” shall be taken to exclude any medium that is capable of carrying a set of instructions (such as carrier waves).

The embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method comprising:
accessing an abstract business process and a specific business process, the specific business process including sub-steps that refine a step in the abstract business process;
validating a refinement between the abstract business process and the specific business process, the validating being performed using a first Petri Net, the refinement including a mapping of one or more of the sub-steps in the specific business process to the step in the abstract business process model;
accessing component models, the respective component models to describe an operation performed by a component corresponding to the component model; and
validating, using a second Petri Net, a grounding between the first sub-step and the component.

2. The method of claim 1, further comprising identifying one or more deadlocks in the first Petri Net or in the second Petri Net.

3. The method of claim 1, further comprising performing a plausibility check in the first Petri Net or the second Petri Net.

4. The method of claim 1, wherein validating the grounding comprises determining that each sub-step of the sub-steps corresponds to an operation place in the second Petri Net.

5. The method of claim 1, wherein validating the grounding comprises:
creating a process Petri Net based on the specific business process;
creating a component Petri Net based on one component model; and
merging the process Petri Net and the component Petri net to generate the second Petri Net.

6. The method of claim 5, wherein validating the grounding further comprises:
treating the final place of the component Petri Net as an operation place and the final place of the process Petri Net as an activity place for the further procedure and extending the grounding function by treating the final place of the process Petri Net as being grounded to the final place of the component Petri Net;
creating a request place for each operation place in the second Petri Net;
designating each input transition of each activity an input transition of the request place corresponding to the operation that the activity grounds on; and
designating each request place as an input place for each input transition of the corresponding operation;
implementing deadlock as an error condition in the second Petri Net;
replacing each first transition of the component Petri Net that is no input transition to an operation by as many new transitions as operation places can be reached following the arcs of the Petri Net and stopping at the first operation place hit; and
designating each new transition as input and output transition of the request place that corresponds to the operation place for which this new transition was created; and
connecting each new transition to the same places as the first transition was connected to;
designating a no request place as an input place of each transition in the process Petri Net and as an output place of every transition of the process Petri Net that is not connected to a request place and as an output place of each input transition of any operation place of the component Petri Net.

7. The method of claim 1, further comprising determining that a particular activity is requested but is not executed and identifying one or more deadlocks based on the determination.

8. The method of claim 1, further comprising determining that a particular operation is requested but is not executed and identifying one or more deadlocks based on the determination.

9. The method of claim 1, wherein validating the refinement comprises:
creating a specific process Petri Net based on the specific business process;
creating an abstract process Petri Net based on the abstract business process; and
merging the abstract process Petri Net and the specific process Petri net to generate the first Petri Net.

10. The method of claim 9, wherein validating the refinement further comprises:
treating the final place of the abstract process Petri Net as an abstract activity place and the final place of the specific process Petri Net as a specific activity place for the further procedure and extending the refinement function by treating the final place of the specific process Petri Net as being refined to the final place of the abstract process Petri Net;
designating for every abstract activity place a new transition as an input and output transition of the abstract activity place;
determining maximal execution set semantics; and
determining minimal execution set semantics

11. The method of claim 10, wherein determining the maximal execution set semantics comprises:
creating a request place for each abstract activity place in the second Petri Net;
designating each input transition of each specific activity an input transition of the request place corresponding to the abstract activity that the specific activity grounds on; and
designating each request place as an input place for each input transition of the corresponding abstract activity;
implementing deadlock as an error condition in the second Petri Net;
replacing each first transition of the abstract process Petri Net that is no input transition to an abstract activity by as many new transitions as abstract activity places can be reached following the arcs of the Petri Net and stopping at the first abstract activity place hit; and designating each new transition as input and output transition of the request place that corresponds to the abstract activity place for which this new transition was created; and
connecting each new transition to the same places as the first transition was connected to;
designating a no request place as an input place of each transition in the specific process Petri Net and as an output place of every transition of the specific process Petri Net that is not connected to a request place and as an output place of each input transition of any abstract activity place of the abstract process Petri Net.

12. The method of claim 10, wherein determining the minimal execution set semantics comprises:
creating a request place for each specific activity place in the second Petri Net;
designating each input transition of each abstract activity an input transition of the request place corresponding to the specific activity that the abstract activity grounds on; and
designating each request place as an input place for each input transition of the corresponding specific activity;
implementing deadlock as an error condition in the second Petri Net;
replacing each first transition of the specific process Petri Net that is no input transition to an specific activity by as many new transitions as specific activity places can be reached following the arcs of the Petri Net and stopping at the first specific activity place hit; and designating each new transition as input and output transition of the request place that corresponds to the specific activity place for which this new transition was created; and
connecting each new transition to the same places as the first transition was connected to;
designating a no request place as an input place of each transition in the abstract process Petri Net and as an output place of every transition of the abstract process Petri Net that is not connected to a request place and as an output place of each input transition of any specific activity place of the specific process Petri Net.

13. The method of claim 9, wherein validating the refinement comprises determining behavioral equivalence based on minimal execution set semantics and based on maximal execution set semantics.

14. The method of claim 1, wherein validating the refinement comprises allowing a first abstract activity to stay active while multiple specific activities are performed that refine the first abstract activity.

15. The method of claim 1, wherein the abstract business process and the specific business process are modeled using business process modeling notation (BPMN).

16. The method of claim 1, wherein the specific business process and the component are modeled using business process modeling notation (BPMN).

17. The method of claim 1, wherein the second Petri Net comprises a component net, a process net, and a grounding function.

18. A system comprising:
a grounding module to validate grounding between one or more activities in a business process model and one or more operations performed by components, the grounding module to validate the grounding using a Petri Net.

19. The system of claim 18, wherein the grounding module is to combine a component model, a process model, and the grounding relation to the Petri Net.

20. A system comprising:
a refinement module to validate a refinement between one or more sub-steps in a specific business process model and one or more steps in an abstract process model, the refinement module to validate the refinement using a Petri Net.

21. A tangible computer-readable medium having instructions embodied thereon, the instructions executable by a processor for performing a method comprising:
accessing an abstract business process and a specific business process, the specific business process including sub-steps that refine a step in the abstract business process;
validating a refinement between the abstract business process and the specific business process, the validating being performed using a first Petri Net;
accessing component models, the respective component models to describe an operation performed by a component corresponding to the component model; and
validating, using a second Petri Net, a grounding between one of the sub-steps and the component model.
